(19) United States
(12) Patent Application Publication
(10) Pub. No.: US 2007/0299798 A1
(43) Pub. Date: Dec. 27, 2007

(54) Time series data prediction/diagnosis apparatus and program thereof

(76) Inventors: Akihiro Suyama, Tokyo (JP); Kouichirou Mori, Saitama-shi (JP); Ryohei Orihara, Tokyo (JP); Hiroji Fukui, Fuchu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/717,732

(22) Filed: Mar. 14, 2007

(30) Foreign Application Priority Data
Jun. 23, 2006 (JP) 2006-173907

(51) Int. Cl. G06F 15/18

(52) U.S. Cl. 706/21

(57) ABSTRACT

A time series data prediction/diagnosis apparatus includes a first creator creating a model series using time series data items sequentially input, a first calculator calculating a prediction error for the model series at each input of a new time series data item, a second creator creating a plurality of model series candidates when an error between the new time series data item and the model series is larger than a predetermined error, a selector selecting an optimal model series among the plurality of model series candidates and set the optimal model series to a new model series, a second calculator calculating a prediction value using the new model series, and a diagnosis unit diagnosing why the prediction value is led for an output value by the second calculator and add a diagnosis result to the prediction value.

### CROSS-REFERENCE TO RELATED APPLICATIONS

This application is based upon and claims the benefit of priority from prior Japanese Patent Application No. 2006-173907, filed Jun. 23, 2006, the entire contents of which are incorporated herein by reference.

### BACKGROUND OF THE INVENTION

1. Field of the Invention

This invention relates to a time series data prediction/diagnosis apparatus and a program thereof.

2. Description of the Related Art

A method for predicting unstable data in which the characteristic of an information source varies with high precision kept by selecting a model on the real-time basis is proposed (refer to JP.A 2005-141601 (KOKAI)). In this document, the technique for extracting a cause of the variation by comparing prediction distributions and data items before and after the model series varies is described. However, in JP.A 2005-141601 (KOKAI), the detail contents are not described. In addition, a diagnostic method for a prediction result is not considered.

### BRIEF SUMMARY OF THE INVENTION

According to one aspect of this invention, highly precise model selection is carried out while a variation in the information source is coped with, a warning is issued on the real-time basis when the model varies or a cause-and-effect relation between items which cause a variation in the model is extracted and presented.

Specifically, A time series data prediction/diagnosis apparatus according to an aspect of the invention comprises: a first creator configured to create a model series using time series data items sequentially input; a first calculator configured to calculate a prediction error for the created model series at each input of a new time series data item; a second creator configured to create a plurality of model series candidates when an error between the new time series data item and the model series is larger than a predetermined error; a selector configured to select an optimal model series among the plurality of model series candidates and set selected model series to a new model series; a second calculator configured to calculate a prediction value using the new model series; and a diagnosis unit configured to diagnose why the prediction value is led for the output value by the second calculator and add a diagnosis result to the prediction value and output it.

### BRIEF DESCRIPTION OF THE SEVERAL VIEWS OF THE DRAWINGS

FIG. 1 is a diagram showing the configuration of a time series data prediction/diagnosis apparatus according to a first embodiment;

FIG. 2 is a flowchart for illustrating the operation of the time series data prediction/diagnosis apparatus according to the first embodiment;

FIGS. 3A and 3B is a diagram for illustrating the operation of a model series candidate creation unit;

FIG. 4 is a diagram showing the configuration of a time series data prediction/diagnosis apparatus according to a second embodiment;

FIG. 5 is a flowchart for illustrating the operation of the time series data prediction/diagnosis apparatus according to the second embodiment;

FIG. 6 is a flowchart for illustrating the schematic operation of a prediction result diagnostic unit according to the second embodiment;

FIGS. 7A and 7B are diagrams showing an example of an orthogonal table according to the second embodiment; and

FIGS. 8A and 8B are diagrams showing an output example of the time series data prediction/diagnosis apparatus according to the second embodiment.

### DETAILED DESCRIPTION OF THE INVENTION

Embodiments of the invention will be described hereinafter with reference to the accompanying drawings.

### First Embodiment

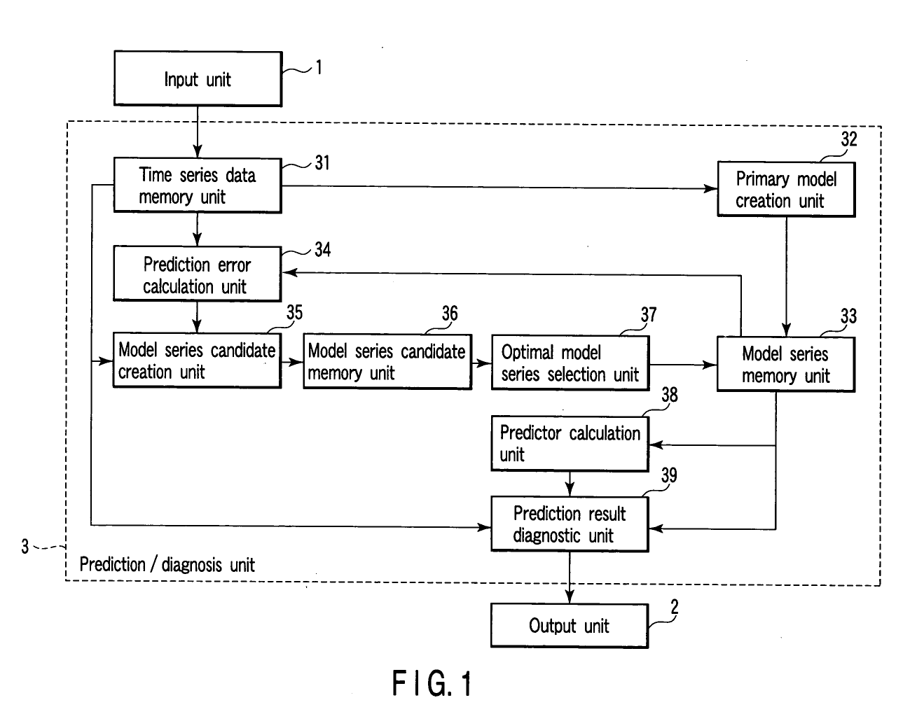

As shown in FIG. 1, the time series data prediction/diagnosis apparatus according to the first embodiment includes an input unit 1, output unit 2 and prediction/diagnosis unit 3. The input unit 1 inputs time series data and outputs the data to the prediction/diagnosis unit 3. The output unit 2 outputs the processing result of the prediction/diagnosis unit 3. The prediction/diagnosis unit 3 performs prediction and diagnosis of time series data. The time series data prediction/diagnosis apparatus can be realized by use of a general-purpose computer and, for example, the input unit 1 receives data input from an input device such as a mouse and keyboard or an external memory device and acquires data by communication with an external device. The output unit 2 includes a device such as a printer and LCD (liquid crystal display device). The prediction/diagnosis unit 3 is a main body of the computer and includes various devices such as a CPU (central processing unit), a ROM and memory device which store programs and the like and a RAM used as a working area at the time of execution of arithmetic operations, for example.

The prediction/diagnosis unit 3 includes a time series data memory unit 31, primary model creation unit 32, model series memory unit 33, prediction error calculation unit 34, model series candidate creation unit 35, model series candidate memory unit 36, optimal model series selection unit 37, predictor calculation unit 38 and prediction result diagnostic unit 39. The respective units have the following functions. The time series data memory unit 31, model series memory unit 33 and model series candidate memory unit 36 may be respectively configured by different memory devices or configured by a single memory device.

The time series data memory unit 31 stores time series data items sequentially input from the input unit 1.

The primary model creation unit 32 creates a linear model used to predict generation of data items based on a preset number of time series data items.

The model series memory unit 33 stores a model series created by the primary model creation unit 32 or a model series selected by the optimal model series selection unit 37 which will be described later.

The prediction error calculation unit 34 compares a value calculated based on the model series stored in the model series memory unit 33 with a value stored in the time series data memory unit 31 and calculates an error therebetween.

The model series candidate creation unit 35 creates candidates of a plurality of linear model series used to predict time series data stored in the time series data memory unit 31.

The model series candidate memory unit 36 stores a plurality of model series candidates created by the model series candidate creation unit 35.

The optimal model series selection unit 37 selects an optimum model series among the model series stored in the model series candidate memory unit 36 and updates and records the selected model series into the model series memory unit 33.

The predictor calculation unit 38 calculates time at which the output value exceeds a limit and outputs the time to the output unit 2.

The prediction result diagnostic unit 39 estimates the reason for the prediction result by calculation and outputs the reason to the output unit 2. In the embodiment, it is supposed that unit variate time series data is used as data to be input.

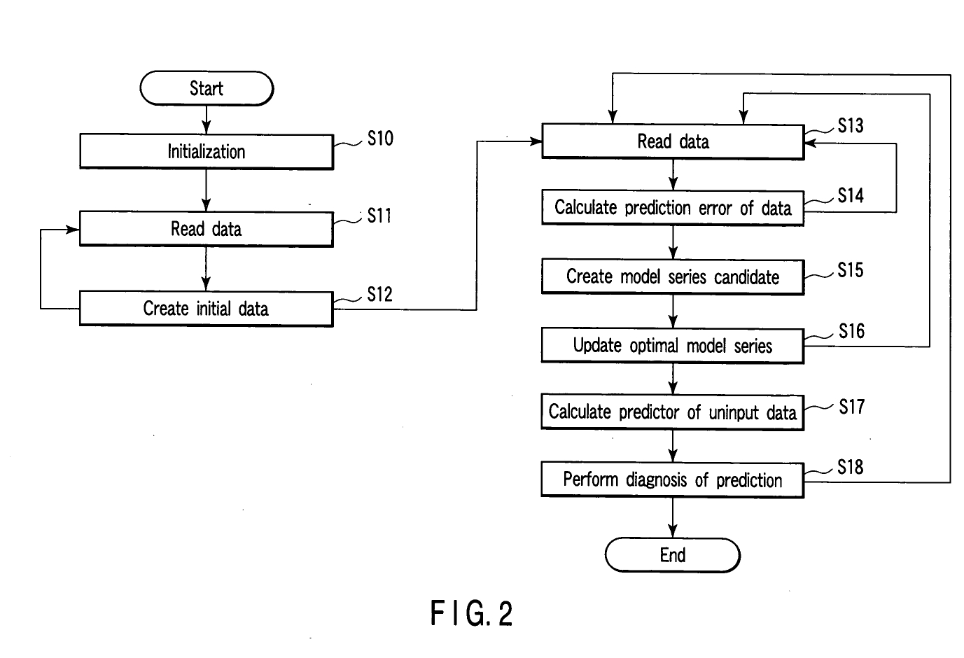

The operation of the time series data prediction/diagnosis apparatus with the above configuration is explained with reference to FIG. 2.

The primary model creation unit 32 initialize time series data stored in the time series data memory unit 31 and model series stored in the model series memory unit 33 (S10). When unit variate time series data is input via the input unit 1, the time series data memory unit 31 additionally stores the unit variate time series data in an input order (S11).

Next, the primary model creation unit 32 determines whether or not a primary model can be created based on the number of data items stored in the time series data memory unit 31. At this time, if it is determined that a sufficiently large number of data items which permit a primary model to be created are stored in the time series data memory unit 31, a linear model suitable for the time series data stored in the time series data memory unit 31 is created (S12). In this case, the primary model creation unit 32 calculates coefficients α, β (linear model coefficients) which minimizes an error obtained when a preset number of time series data items are applied in the equation (1) and stores a model application time range and linear model coefficients. In the primary model, the application time range t is set larger than 0.

Y=αX+β (1)

The linear model is stored in the model series memory unit 33.

When new unit variate time series data is input via the input unit 1 (S13), the new unit variate time series data is additionally stored in the time series data memory unit 31 like the case of the step S11.

The prediction error calculation unit 34 calculates an error between the new unit variate time series data and a prediction value estimated from the model series stored in the model series memory unit 33 (S14). Specifically, the prediction error calculation unit 34 reads out unit variate time series data at time t from the time series data memory unit 31 and reads out a model coefficient corresponding to the time t from the model series memory unit 33. Then, it calculates an error between the value calculated according to the equation (1) and the unit variate time series data read out from the time series data memory unit 31. At this time, if the error is smaller than a preset error, the process returns to the step S13 and if the error is larger than the preset error, the process proceeds to the step S15. In this case, the magnitude of the error may be determined by, for example, calculating errors for data items which are considered to be suited to a linear model based on the linear model and setting the largest error among the calculated errors as a reference error and the process may proceed to the step S15 when the error becomes larger than the reference error.

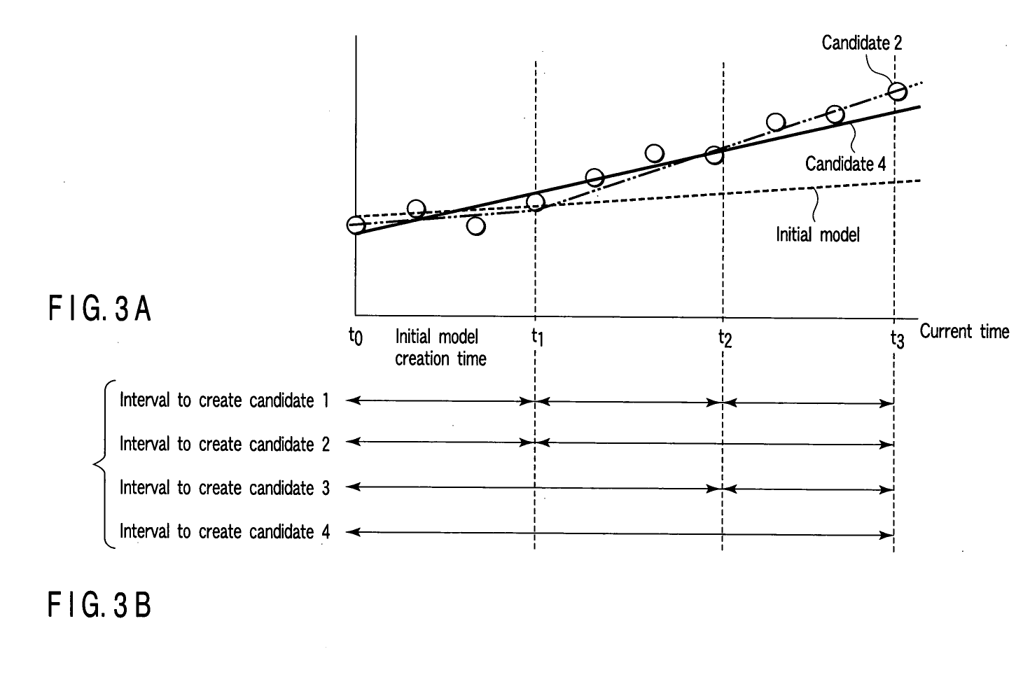

If it is determined that the error is larger than the preset error as the result of calculation by the prediction error calculation unit 34, the model series candidate creation unit 35 creates a plurality of new model series (S15). The model series are stored in the model series candidate memory unit 36. The operation of the model series candidate creation unit 35 is explained in detail with reference to FIGS. 3A and 3B.

The model series candidate creation unit 35 reads out time series data stored in the time series data memory unit 31 and determines window width derived based on the number of data items required at the time of creation of the primary model. For example, the window width is given as “primary model creation time” from t₀ to t₁ in FIGS. 3A and 3B. Then, intervals used to create model series candidates are assigned by use of a combination of a constant multiple of the window width. That is, in FIGS. 3A and 3B, three intervals from t₀ to t₁, from t₁ to t₂ and from t₂ to t₃ are assigned. Then, a plurality of model series candidates are created by adequately combining the three spaces. In FIG. 3B, a method of assigning the intervals to create model series candidates from a candidate “1” to a candidate “4” is shown. In the graph of FIG. 3A, linear models based on the candidate “2” and candidate “4” are shown. The candidate “2” is an example obtained by creating a model by use of an interval of one window width from t₀ to t₁ and an interval of two window widths from t₁ to t₃ and the candidate “4” is an example obtained by creating a model by use of an interval of three window widths from t₀ to t₃. For example, as shown in FIGS. 3A and 3B, coefficients of linear models are calculated by using the equation (1) like the case of the primary model creation unit 32 in combinations of the candidate “1” to the candidate “4”. Then, model application time ranges and linear model coefficients for the respective model series candidates are stored in the model series candidate memory unit 36.

The optimal model series selection unit 37 reads out a model application time range and linear model coefficient for each candidate from the model series candidate memory unit 36 and derives a candidate which minimizes a value obtained by the following equation (2).

$$l = - \frac{N}{2} log ( 2 π {σ}^{2} ) - \frac{1}{2 {σ}^{2}} {\sum }_{i = 1}^{N} {ɛ}_{i}^{2} + \frac{m}{2} log N \qquad ( 2 )$$

Then, one optimal model series is selected from a plurality of model series stored in the model series candidate memory unit 36 (S16). The equation (2) indicates an MDL information reference obtained when an error average ε with respect to models is “0” and follows the normal distribution of dispersion σ, N indicates the number of data items, σ indicates dispersion, and εᵢ indicates an error or difference between an actual value and a value obtained by reading out the linear model coefficient stored in the model series memory unit 33 and derived by calculation according to the equation (1). In the example shown in FIGS. 3A and 3B, the candidate “2” is selected as the optimal model series and time t₁ becomes a breakpoint of the model series. Then, the model series memory unit 33 stores the model application time range and linear model coefficient of the model series candidate which is selected by the optimal model series selection unit 37 and becomes minimum and updates the memory content into one selected model series. That is, in this case, the model series memory unit 33 stores only the newest model series. At this time, if the number of constituents of the model series varies or if the time series data exceeds a given threshold value, the process proceeds to the step S17. In other cases, the process returns to the step S13.

In the step S16, the predictor calculation unit 38 reads out the linear model coefficient at the time of t>t₃ stored in the model series memory unit 33 when the number of constituents of the model series in the model series memory unit 33 increases or when a value of the time series data at the current time t₃ exceeds a warning level value. Then, the predictor calculation unit 38 calculates time at which data exceeds a danger (fault) level value (>warning level value) (S17). More specifically, the predictor calculation unit 38 carries out calculation based on the equation (1) or (2) to derive time at which the danger (fault) level value is reached and outputs the thus derived time.

The prediction result diagnostic unit 39 reads out a model series stored in the model series memory unit 33 and a time series data set stored in the time series data memory unit 31 and additionally outputs the reason why the prediction is attained (S18). Specifically, the prediction result diagnostic unit 39 reads out final variation time (time t₁ in FIGS. 3A and 3B) from the model series memory unit 33 when the number of constituents of the model series in the model series memory unit 33 increases, further reads out time series data before and after the time t₁ from the time series data memory unit 31 and outputs a variation in the value as the result of diagnosis.

### Second Embodiment

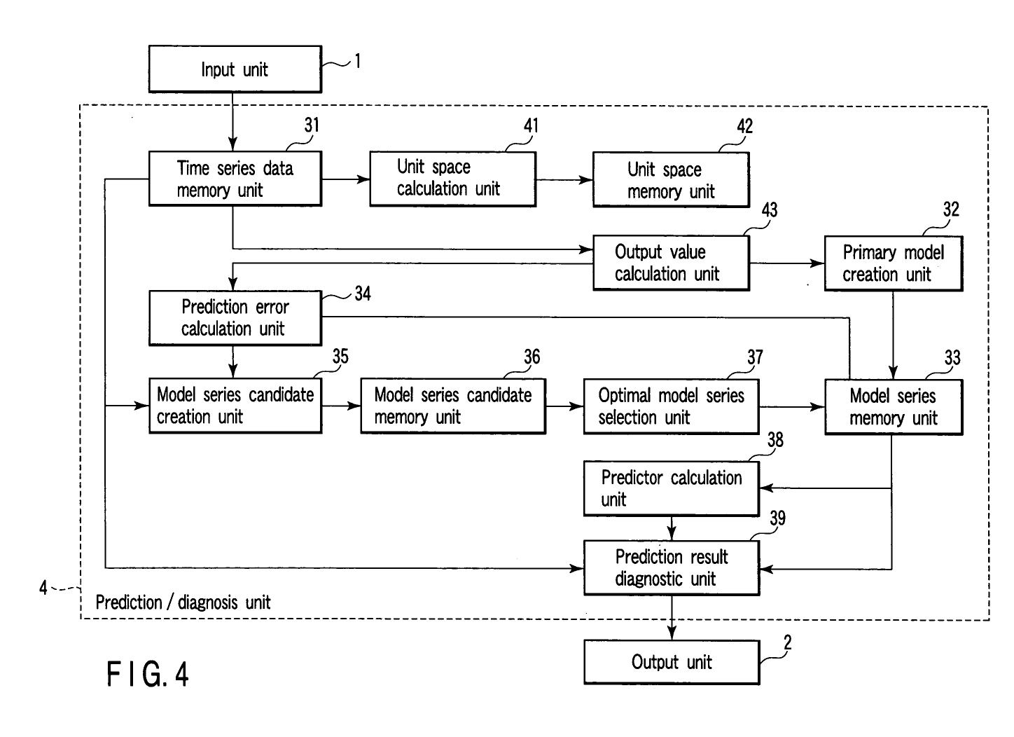

A time series data prediction/diagnosis apparatus according to a second embodiment is explained with reference to the accompanying drawings. The time series data prediction/diagnosis apparatus according to the embodiment includes an input unit 1, output unit 2 and prediction/diagnosis unit 4. In FIG. 4, portions which are the same as those of FIG. 1 are denoted by the same reference symbols. In FIG. 4, the prediction/diagnosis unit 4 further includes a unit space calculation unit 41, unit space memory unit 42 and output value calculation unit 43 in addition to the prediction/diagnosis unit 3 shown in FIG. 1. The other configuration is the same as that of FIG. 1. In the embodiment, multivariate time series data is dealt with instead of the unit variate time series data.

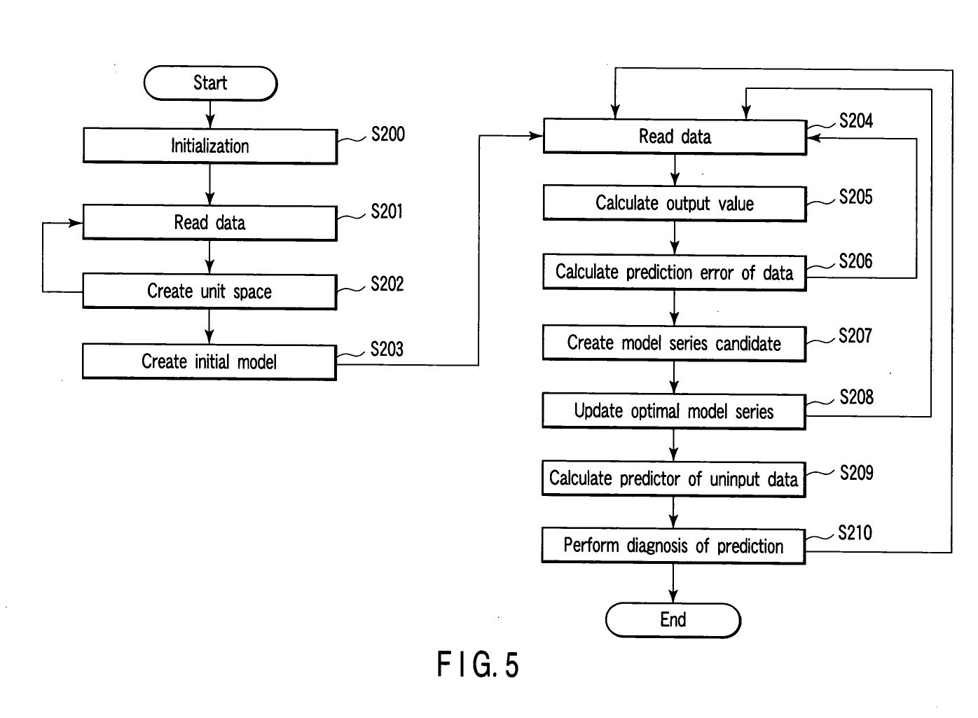

The time series data prediction/diagnosis apparatus according to the second embodiment with the above configuration is explained with reference to FIG. 5.

First, time series data stored in the time series data memory unit 31, model series stored in the model series memory unit 33 and unit space memory unit 42 are initialized (S200). When multivariate time series data X is input via the input unit 1, the time series data memory unit 31 additionally stores the multivariate time series data items X in an input order (S201).

The unit space calculation unit 41 reads out the number of data items stored in the time series data memory unit 31 and determines whether it is possible to create a unit space or not. It is preferable that the number of data items used to create the unit space will be three times the number of items (the number of variates) or more. If it is possible to create the unit space, it reads out all of the multivariate time series data items X stored in the time series data memory unit 31 to calculate unit space information (S202). Specifically, the unit space calculation unit 41 derives an average of variates of the input multivariate time series data items X and standard deviation and calculates a correlation coefficient matrix of the variates and an inverse matrix of the correlation coefficient matrix. Then, the average of the variates which are unit space information, standard deviation, correlation coefficient matrix and inverse matrix of the correlation coefficient matrix are stored into the unit space memory unit 42.

The output value calculation unit 43 reads out multivariate time series data items X at respective times stored in the time series data memory unit 31 and unit space information stored in the unit space memory unit 42 and calculates an output value Y (S203). In this case, the output value Y is data corresponding to the data of the time series data prediction/diagnosis apparatus according to the first embodiment. Like the first embodiment, the primary model creation unit 32 creates a primary model and the thus created primary model is stored in the model series memory unit 33 as in the first embodiment.

After this, if new time series data X′ having a plurality of items is input, the new time series data X′ is additionally stored in the time series data memory unit 31 as in the step S201 (S204).

The output value calculation unit 43 reads out the time series data X′ finally stored in the time series data memory unit 31 and unit space information stored in the unit space memory unit 42 and calculates an output value Y (S205). Specifically, the output value calculation unit 43 reads out the average of variates and standard deviation from the unit space memory unit 42 with respect to the input multivariate time series data X and normalizes the multivariate time series data X by use of the above values. The output value calculation unit 43 further reads out the inverse matrix of the correlation coefficient matrix from the unit space memory unit 42 and calculates an output value by use of the inverse matrix and normalized multivariate time series data X. In this case, a function indicated by the following equation (3) is used as the calculation function for the output value.

$${D ( t )}^{2} = \frac{1}{k} X ( t ) {R}^{- 1} {X ( t )}^{T} \qquad ( 3 )$$

The above equation (3) is one example of the calculation function for the output value and called a Mahalanobis distance in the Taguchi method.

In the equation (3), X(t) is normalized input data at time t and is given by the following equation.

$$X ( t ) = ( \frac{{x}_{1} ( t ) - {m}_{1}}{{σ}_{1}} , … , \frac{{x}_{k} ( t ) - {m}_{k}}{{σ}_{k}} )$$

where X(t)T denotes a transposed matrix of X(t). Further, in the above equation, σᵢ and mᵢ indicate a standard deviation and average of variates i in respective unit spaces. Further, xᵢ(t) indicates an observed value of the variate i at time t or a value obtained by subjecting the observed value to a primary process.

The operation of the steps S206 to S209 is the same as that of the steps S14 to S17 of FIG. 2, and therefore, the explanation thereof is omitted.

The prediction result diagnostic unit 39 reads out model series stored in the model series memory unit 33 and a time series data set stored in the time series data memory unit 31 and additionally outputs the reason why the prediction is reached (S210). The detail prediction method is explained below.

A case wherein multivariate time series data X of {{x₁(1), x₂(1), . . . , xₖ(1)}, . . . , {x₁(τ), x₂(τ), . . . , xₖ(τ)}, . . . , {x₁(T), x₂(T), . . . , xₖ(T)}} is input is considered. In this example, the model series is configured by two models, τ indicates variation time of the model series stored in the model series memory unit 33 and T indicates current time.

The prediction result diagnostic unit 39 calculates factors which largely contribute to coincidence of models at time t=1, . . . , τ and derives characteristic values of factors which deviate from the models at respective times of time t=τ, . . . , T by calculation. A set of factors whose characteristic values become larger than the threshold value in both of the above intervals is used as the result of diagnosis for prediction. At this time, transition of the results of diagnosis at time t=τ, . . . , T can be output by extracting a factor variation at each time t=τ, . . . , T.

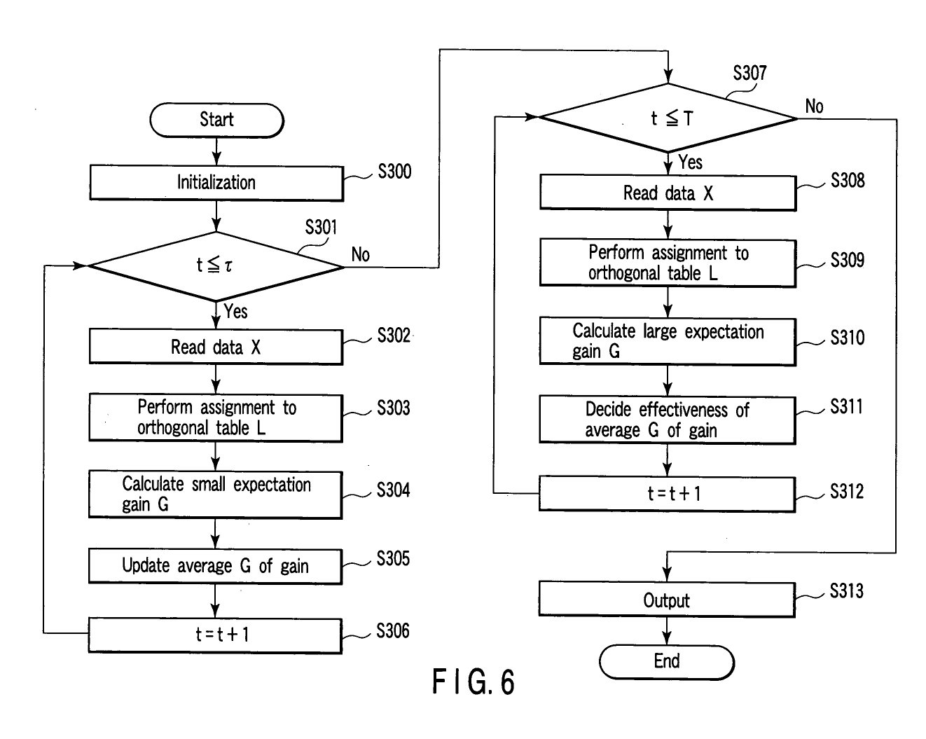

The flow of the process of the prediction result diagnostic unit 39 is explained in detail with reference to FIG. 6.

Time t is initialized to “1” and the average Gbᵢ (i=1, . . . , k) of gains is initialized to “0” (S300).

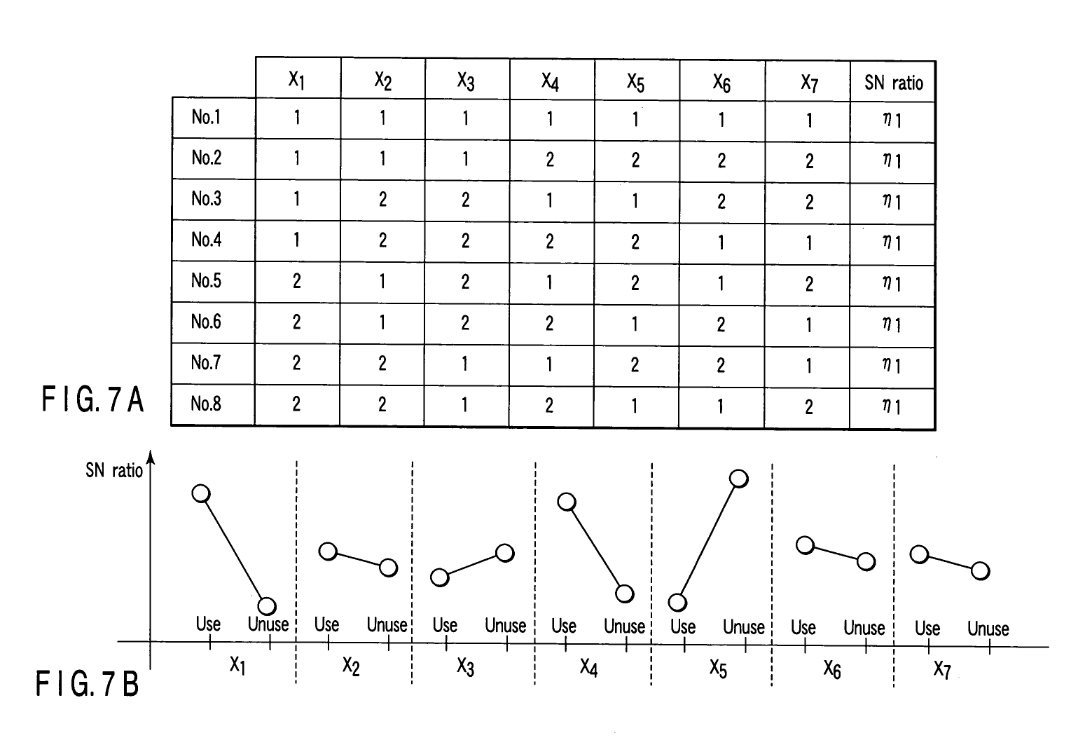

Then, whether or not time t is before the time τ of a breakpoint of the model is determined (S301). If the time t is before the time τ (“Yes” in S301), the prediction result diagnostic unit 39 first reads out multivariate time series data X(t) from the time series data memory unit 31 (S302). The multivariate time series data X(t) is assigned to a two-level orthogonal table Lⁿ in which the first level: “variate i is used” and the second level: “variate i is not used” are set (S303). In this case, Lⁿ is a two-level orthogonal table having the minimum size n which causes the number of variates to become equal to or larger than k. FIGS. 7A and 7B are diagrams showing an example of an orthogonal table when the number of variates is set to 5 to 7. The orthogonal table is an assignment table for experiments having a characteristic in which all of the combinations of the levels of desired two variates (desired two columns in FIG. 7A) appear by the same number of times and it becomes possible to perform experiments for deriving characteristics associated with a large number of variates by a small number of times.

A gain difference Gdi(t) (i=1, . . . , k) of each variate associated with a small expectation characteristic of the two-level orthogonal table Lⁿ created in the step S303 is derived by use of the equations (4) and (5) (S304). D(d, t)² is an output value (Mahalanobis distance) obtained when an experiment is performed by using only variates of the first level of the experiment No. d (d=1, . . . , n) at time t.

In order to lower the calculation cost, it is desirable to calculate the inverse matrix of the correlation matrix in each experiment in the step S202 of FIG. 5 and store the same.

$${G}_{i} ( t ) = {\sum }_{d = 1}^{n} C ( d , i , t ) \\ C ( d , i , t ) = \{ \begin{matrix}{η}_{d} ( t ) & ( \begin{matrix}when first level of orthogonal \\ table \{ d , i \} is used\end{matrix} ) \\ 0 & ( \begin{matrix}when second level of orthogonal \\ table \{ d , i \} is used\end{matrix} )\end{matrix} \qquad ( 4 )$$

n_{d}(t)=−10×log D(d,t)² (5)

The average gain difference Gdbᵢ (i=1, . . . , k) of each variate is updated by use of the gain difference Gdᵢ(t) (i=1, . . . , k) of each variate (S305).

Then, the time t is incremented and the process returns to the step S301 (S306). If the time t becomes larger than time τ, the process proceeds to the step S307 (“No” in S301).

In the step S307, if the time t is before the time T, the process proceeds to the step S308 (“Yes” in S307).

The multivariate time series data X(t) is read out from the time series data memory unit 31 by the same procedure as in the step S302 (S308).

The multivariate time series data X(t) is assigned to the two-level orthogonal table Lⁿ by the same procedure as in the step S303 (S309).

A gain difference Gdᵢ (i=1, . . . , k) of each variate associated with a large expectation characteristic of the two-level orthogonal table Lⁿ created in the step S309 is derived by use of the equations (4) and (6) (S310).

$${η}_{d} ( t ) = - 10 \times log \frac{1}{{D ( d , t )}^{2}} \qquad ( 6 )$$

The average gain difference Gdbᵢ of the variate derived in the step S305 and the gain difference Gdᵢ of each variate associated with a large expectation characteristic derived in the step S310 are evaluated by use of the following equation (7) and a variate index i larger than the threshold value and time t are temporarily stored (S311).

$$F ( t ) = \frac{{Gd}_{i} ( t ) \times {Gdb}_{i}}{{Gd}_{i} ( t ) + {Gdb}_{i}} \qquad ( 7 )$$

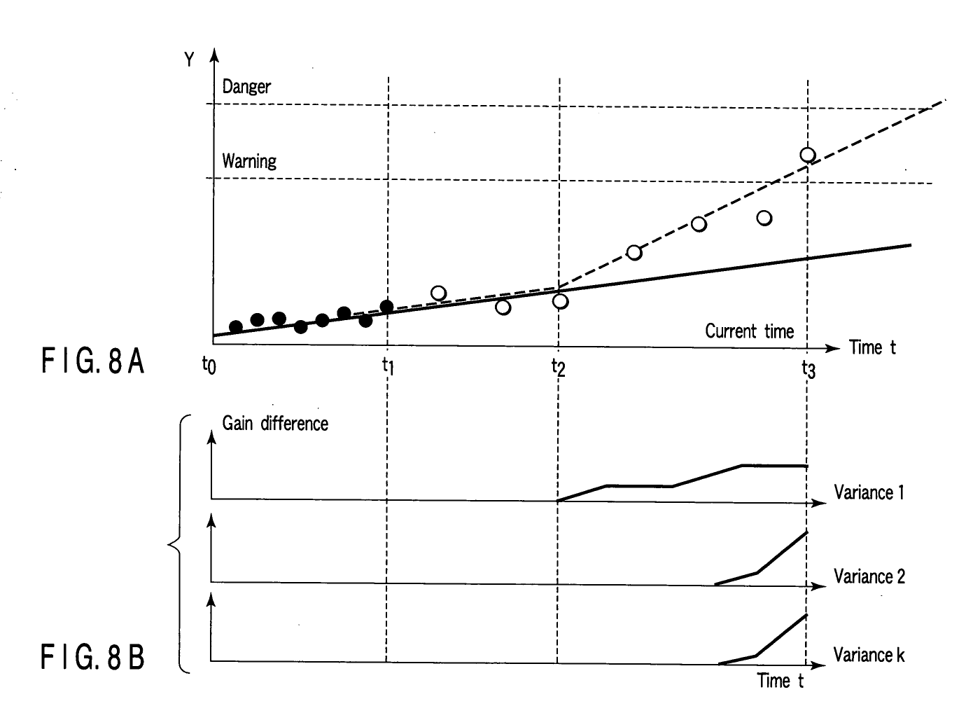

Then, the time t is incremented and the process returns to the step S307 (S312) and if the time t becomes larger than the time T, the process proceeds to the step S313 (“No” in S307). After this, the variate index i and time t temporarily stored in the step S311 are read out and sorted according to time t and transition of the gain difference is displayed as graphs as shown in FIGS. 8A and 8B, for example (S313).

As shown in FIG. 8A, it is understood that outputs are different in the first interval from time t₀ to t₁, the second interval from time t₁ to t₂ and the third interval from time t₂ to t₃. More specifically, in the first and second intervals, the numbers of input data items are different and the number of input data items in the second interval is smaller than that in the first interval. However, since the difference in the linear model does not vary very much in the first and second intervals, the same model can be applied. In the model after the time t₂, the number of data items can be regarded as being the same as in the second interval, but the inclination of the linear model is changed. Therefore, it is considered that the model applied has been changed. The model before the breakpoint of the time t₂ (that is, the model in the first and second intervals) is set as a normal model and the model after the breakpoint (that is, the model in the third interval) is set as an abnormal model.

At this time, it is supposed that a diagram shown in FIG. 8B is obtained when gain differences are taken for respective variates and the sorting process is performed for the gain differences. In this case, first, the gain difference for a variate 1 varies at the time t₂. After this, the gain differences for a variate 2, . . . , variate k vary. Thus, it is understood that the variate which gives the greatest contribution to the variation of the model is the variate 1 and the variate 2, . . . , variate k vary due to the influence by the variate 1. In this case, it is preferable to derive items which contribute to the normal model and abnormal model and consider the items as a factor of the variation in the model. Thus, in the embodiment, the type of the variate which contributes to the variation in the model can be analyzed. Further, a warning may be issued when the warning line is exceeded after the breakpoint of the time t₂.

According to the above embodiments, the model can be fit for a simple and highly precise model while a change in information is coped with. This is because a single model or a plurality of divided models are used as an optimal model by using the efficient method for dividing windows based on the length of a unit space while the penalty represented by a plurality of models and a difference between information and a model is set as a reference.

Further, a warning can be issued on the real-time basis when the model varies. This is because it is supposed that a change in the number of models indicates a rapid variation in information and a warning is issued in a case where the number of models varies when the models are sequentially changed.

Also, the detail diagnosis for a variation in the model can be performed. This is attained by analyzing a factor fit for the model before division and a factor which deviates from the model after division in the intervals before and after the dividing point of the models and using a factor which causes the values of the above two factors to become large as the diagnosis for the result of prediction.

According to the embodiments, model selection with high precision can be carried out while a variation in the information source is coped with, a warning can be issued on the real-time basis when the model varies or a cause-and-effect relation between items which cause a variation in the model can be extracted and presented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A time series data prediction/diagnosis apparatus comprising:
a first creator configured to create a model series using time series data items sequentially input;
a first calculator configured to calculate a prediction error between the model series data and a new time series data at each inputting the new time series;
a second creator configured to create a plurality of model series candidates when the prediction error is larger than a predetermined threshold;
a selector configured to select an optimal model series among the plurality of model series candidates and set the optimal model series to a new model series;
a second calculator configured to calculate a prediction value using the new model series; and
a diagnosis unit configured to diagnose why the prediction value is led for an output value by the second calculator and add a diagnosis result to the prediction value.

2. The apparatus according to claim 1, further comprising:
a first memory unit configured to store the time series data sequentially input;
a second memory unit configured to store the model series created by the first creator; and
a third memory unit configured to store the plurality of model series candidates created by the second creator.

3. The apparatus according to claim 2, wherein the second memory unit stores only a latest model series.

4. The apparatus according to claim 2, wherein the selector substitutes the model series stored in the second memory unit to a latest model series.

5. The apparatus according to claim 1, wherein the first creator creates a primary model by setting a number of three times or more number of items as a number of minimum data items.

6. The apparatus according to claim 5, wherein the second creator creates the plurality of model series candidates each having plural or single model series by linear model estimation using a time window width in which the minimum number of data is obtained.

7. The apparatus according to claim 5, wherein the second creator creates the plurality of model series candidates each having plural or single model series.

8. The apparatus according to claim 2, wherein the selector selects an optimal model series among the plurality of model series candidates stored in the third memory unit by a reference similar to an MDL information reference and substitute it to the model series stored in the second memory unit.

9. The apparatus according to claim 2, wherein the diagnosis unit diagnoses the prediction result when a number of model series stored in the second memory unit changes, sets a model after a latest breakpoint of the model series to an abnormal model, sets a model before a latest breakpoint of the model series to a normal model, obtains contributing items for the normal model and the abnormal model, respectively, diagnoses items appeared in both of them as an compound factor of a change of the model series, and output as the diagnosis result.

10. A computer readable medium storing a program for predicting and diagnosing time series data items, comprising:
code for creating a model series using time series data sequentially input;
code for calculating a prediction error between the model series and a new time series data at each input of the new time series;
code for creating a plurality of model series candidates when the prediction error is larger than a predetermined threshold;
code for selecting an optimal model series among the plurality of model series candidates and set the optimal model series to a new model series;
code for calculating a prediction value using the new model series; and
code for diagnosing why the prediction value is led for an output value and add a diagnosis result to the prediction value.
